(19) United States
(12) Patent Application Publication
(10) Pub. No.: US 2019/0081533 A1
(43) Pub. Date: Mar. 14, 2019

(54) HAPTIC ACTUATOR

(71) Applicant: FUKOKU CO., LTD., Ageo-shi (JP)

(72) Inventors: Grigori EVREINOV, Tampere (FI); Ahmed FAROOQ, Tampere (FI); Daisuke TAKAHATA, Ageo-shi (JP); Tetsuya ARASAWA, Ageo-shi (JP)

(21) Appl. No.: 15/913,193

(22) Filed: Mar. 6, 2018

(30) Foreign Application Priority Data
Sep. 12, 2017 (JP) 2017-174948

(51) Int. Cl. H02K 7/06

(52) U.S. Cl. CPC H02K 7/063; G06F 3/016

(57) ABSTRACT

A haptic actuator includes a housing, an actuator having a first shaft and configured to rotate the shaft, a rotation-to-translation converter being coupled to the first shaft of the actuator, a second shaft provided in parallel to or in coaxial with the first shaft of the actuator; and a displacement unit configured to move along the second shaft depending on a movement of the rotation-to-translation converter.

### CROSS-REFERENCE TO RELATED APPLICATION

This application claims priority from Japanese Patent Application No. 2017-174948 filed on Sep. 12, 2017, the entire contents of which are incorporated herein by reference.

### FIELD

The present invention generally relates to the haptic actuators and, more particularly, to a haptic actuator that converts/translates its rotation motion of an electric motor into a motion of a moving mass to generate tactile sensations as a haptic output modality in various objects of interaction.

### BACKGROUND

Consumer products, such as mobile and wearable devices, smart garments (for occupational use, medical applications or fitness) and their accessories, may generally include miniature vibrators for generating tactile information such as conventional (warnings) and conditional cues (directional, numerical, rhythmic and so on). For example, a mobile phone and wrist wearable devises (as smart watches and trackers) have embedded vibrators for generating vibration tactile feedback signals while being in contact with the user.

Among different types of actuators, miniature DC motors with rotating eccentric mass (also known as pager motors) were the most popular, robust and efficient technology for a long time in mobile and wearable electronic devices equipped with tactile feedback. Although eccentric rotating mass (ERM) vibration motors have a simple configuration, they also have limited functionality.

The ERM vibration motors mostly generate harmonic vibrations and distributing force vectors between two orthogonal directions of the plane which are orthogonal to the axis of the motor shaft that often makes them less efficient than unidirectional (linear or/and resonant) haptic actuators. Though speed and torque of a DC motor could be controlled for proper performance, the centripetal and centrifugal forces of an eccentric rotating mass cause continuous micro-displacements of the motor and continuously vary the vector of force moment resulting in the variation of transmitted kinetic energy to the motor mount/suspension.

Many improvements have been made to the ERM actuator configuration design (PL1 and PL2) and to controlling their performance characteristics during actuation (PL3, NPL1, NPL2 and NPL3) as well as the configuration of assembly of multiple ERM actuators (PL4 and PL5).

However, minor improvements of extended functionality to generate complex patterns of vibration signals significantly complicates the actuator control or/and their production costs.

In Linear Resonant Actuators (LRA) a movable body (a displacement unit or a mass) is attached to a vibration substrate (a spring or an elastic body) and driven back and forth with the use of various physical forces and phenomena (electric or electromagnetic field, piezoelectric and magnetostrictive effects and so on) or a “smart material” such as electromechanical polymer-metal composites and alloys (e.g., NPL4) electro/photo/temperature/magneto-active materials and so on.

Many of these actuators (PL6, PL7, PL8, PL9, PL10, NPL5 and NPL6), and the devices that they interact with, have their own resonant frequencies, and therefore, it is very important to optimally and dynamically determine and control driving signals to generate the haptic effects in the most effective and efficient way, as disclosed in PL6 to optimize the actuation of an LRA device.

However, this type of actuators typically has limited functionality to produce vibration signals in a relatively narrow bandwidth of frequencies (being only efficient near the resonant frequency +/−10 Hz). Furthermore, the resonance tuning of such actuators is also relatively difficult as the electromagnetic force generated by the coil has a non-linear function of displacement of a mass or/and magnets assembly out of the coil.

The LRAs are inefficient at generating a highly asymmetric form of vibration signal over a wide range of oscillation frequencies. Some actuators consume significant power and are limited in their applications because of their size.

On the contrary, DC motors used for ERM provide stable torque and power consumption due to their configuration of magnetic system. Therefore, the ERM actuators would be the most attractive for consumer electronics and manufacturers if they would be able to outperform mechanical characteristics of linear resonant actuators (LRA). In particular, linear actuators based on rotation motors would have lower costs and higher efficiency (with respect to the ratio of the parameter of actuation to power consumption) if they could provide periodic unidirectional actuation of their movable mass (same as ERM) with assigned function of distribution of the force moment over time of impacting.

This can significantly extend a functionality of the haptic actuator which has been realized in the present invention.

### CITATION LIST

### Patent Literature

Patent Literature 1: U.S. Pat. No. 3,383,531-A

Patent Literature 2: US-2003-201975-A

Patent Literature 3: US-2014-327530-A

Patent Literature 4: U.S. Pat. No. 7,182,691-B

Patent Literature 5: WO-2015-123361-A

Patent Literature 6: U.S. Pat. No. 7,843,277-B

Patent Literature 7: U.S. Pat. No. 9,350,222-B

Patent Literature 8: WO-2010-067753-A

Patent Literature 9: U.S. Pat. No. 9,142,754-B

Patent Literature 10: US-2015-316933-A

### Non-Patent Literature

Non-Patent Literature 1: Haptics: Solutions for ERM and LRA Actuators. Texas Instruments. Avalable at: http://www.ti.com.cn/cn/lit/ml/sszb151/sszb151.pdf

Non-Patent Literature 2: Haptic Driver with Auto Resonance Tracking for LRA and Optimized Drive for ERM. Available at: http://www.ti.com/lit/ds/symlink/drv2603.pdf

Non-Patent Literature 3: Benefits of Auto Resonance Tracking. Application report SLOA188 October 2013. Texas Instruments. Avalable at: http://www.ti.com/lit/an/sloa188/sloa188.pdf

Non-Patent Literature 4: Sia Nemat-Nassera and Jiang Yu Li (2000) Electromechanical response of ionic polymer-metal composites. Journal of Applied Physics, Vol. 87, n. 7, pp. 3321-3332

Non-Patent Literature 5: Tae-Heon Yang, Dongbum Pyo, Sang-Youn Kim, et al. (2011) A New Subminiature Impact Actuator for Mobile Devices. In: IEEE World Haptics Conference 2011, 21-24 Jun., Istanbul, Turkey, pp. 95-100. DOI: 10.1109/WHC.2011.5945468

Non-Patent Literature 6: Cavarec, P. E., Ahmed, H. B., Multon, B. (2002) New multi-rod linear actuator for direct drive, wide mechanical band pass applications. In: Industry Application Conference. IEEE, Vol. 1, pp. 369-376. DOI: 10.1109/IAS.2002.1044114

### SUMMARY

One object of the present invention is to provide a haptic actuator in which a rotation movement is translated converted/translated into an oscillation movement to realize the intended haptic pattern.

A haptic actuator, comprising: a housing; an actuator having a first shaft and configured to rotate the shaft; a rotation-to-translation converter being coupled to the first shaft of the actuator; and a second shaft provided in parallel to or in coaxial with the first shaft of the actuator; and a displacement unit configured to move along the second shaft depending on a movement of the rotation-to-translation converter.

The haptic actuator of the present invention is capable of generating haptic vibrations with a given force distributed along each time period with a simple configuration/structure, low production cost, strong force and long stroke, as compared with a linear resonance actuator and/or an eccentric rotating mass vibration motor.

### BRIEF DESCRIPTION OF DRAWINGS

FIG. 1 is a block diagram of a haptic actuator according to a first embodiment of the present invention.

FIGS. 2A and 2B illustrate a configuration of the haptic actuator according to the first embodiment.

FIGS. 3A to 3C illustrate a configuration of a haptic actuator according to a second embodiment of the present invention.

FIG. 4 is a cross-sectional view taken along a line A-A in FIG. 3A.

FIG. 5 is a cross-sectional view taken along a line B-B in FIG. 3B.

FIGS. 6A and 6B illustrate a configuration of a haptic actuator according to a third embodiment of the present invention.

FIG. 7 illustrates function and operation of a rotation-to-oscillation converter of the haptic actuator.

FIGS. 8A-8C illustrate formation patterns of slots or grooves for defining the trajectory of the pin to cause the displacement unit to oscillate.

FIG. 9 is a cross-sectional view of the slot or groove taken along a line C-C in FIG. 8A

FIG. 10 illustrates a configuration of a haptic actuator according to a fourth embodiment of the present invention.

FIG. 11 is a block diagram illustrating the haptic actuator integrated with sensors and a microcontroller.

### EMBODIMENTS

The embodiments of the present invention will be described with reference to the accompanying drawings. In the drawings and the description, the same reference numbers are used to refer to the same or like parts.

The embodiments allow the displacement unit to move in a given direction to thereby generate haptic vibrations with a given force distributed along each time period, for example, unidirectional sinusoidal force (harmonic vibrations), asymmetric (saw-tooth like) oscillations or/and symmetric (close to triangle or rectangle) wave forms and more complex haptic patterns.

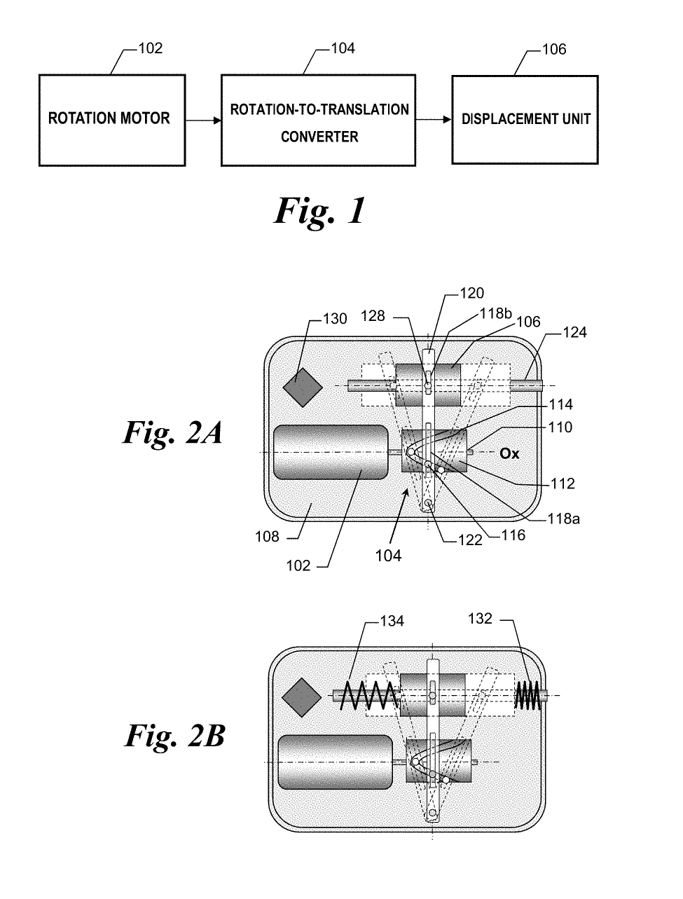

Refer to FIG. 1. As shown in FIG. 1, the haptic actuator includes a rotation motor 102 (an actuator configured to rotate the first shaft 110), a rotation-to-oscillation converter 104 and a displacement unit 106.

Any kind of motor can be used as the rotation motor 102, and the rotation-to-oscillation converter 104 converts both directions (clockwise and counterclockwise) of rotation movements into oscillation movements of the displacement unit 106. The rotation-to-oscillation converter 104 may be configured to covert different directions of the rotation movements of the rotation motor 102 into different oscillation movements of the displacement unit 106.

Refer to FIG. 2A. FIG. 2A illustrates a haptic actuator according to a first embodiment of the present invention.

As shown in FIG. 2A, the haptic actuator according to the first embodiment has a support housing 108. In the support housing 108, the components for the mechanical linkage and the electronic control are installed.

According to the first embodiment, a cylindrical cam 112 is rigidly fixed to a first shaft 110 of the rotation motor 102 so as to be concentric therewith.

Any kinds of motors, such as a DC motor, an AC motor, or a stepper motor can be used as the rotation motor 102.

The cylindrical cam 112 is linked with a planar follower 120. The follower 120 has a first slot 118a in which a first pin 116 is movably provided, and a second slot 118b in which a second pin 128 is movably provided. One end of the follower 120 is pivotally supported on a third shaft 122, which is orthogonal to the first shaft 110, so that the follower 120 is swingable with the third shaft 122 as a center.

The cylindrical cam 112 has a groove 114 formed on an outer peripheral surface as a curved surface. The first pin 116 is inserted into the groove 114. As the first shaft 110 of the rotation motor 102 rotates, the first pin 116 moves along the trajectory of the groove 114 within the first slot 118a, and the follower 120 is thereby caused to swing.

The displacement unit 106 is oscillatably mounted on a second shaft 124, which is parallel to the first shaft 110. The second pin 128 is connected with the displacement unit 106 so as to move together therewith. As the follower 120 swings, the second pin 128 moves along within the second slot 118b, and the displacement unit 106 is thereby caused to oscillate along the second shaft 124.

The groove 114 is continuous and endless in a rotation direction of the cylindrical cam 112. The first pin 116 oscillates in accordance with a rotation movement of the cylindrical cam 112 along an axis Ox of the cylindrical cam 112 which being guided by the groove 114. Therefore, a return spring is not necessary.

According to the above-mentioned configuration, the rotation movement of the rotation motor 102 can be translated into the oscillation movement of the displacement unit 106.

In the haptic actuator according to the first embodiment, the cylindrical cam 112 having the groove 114, the follower 120 having the first slot 118a and the second slot 118b, the first pin 116 and the second pin 128 form the rotation-to-oscillation converter 104.

The haptic actuator may further include contactless sensors (not shown) of any kind (e.g., optical, magnetic etc) to acquire the exact positions of the displacement unit 106 and the first shaft 110 of the rotation motor 102 (or the cylindrical cam 112). In this case, the microcontroller 130 may adjust output (electrical signals) of the driving mechanism based on the acquired information.

A spring or elastic bumper 132 and a spring or elastic bumper 134 may be further provided on the second shaft 124, as shown in FIG. 2B. The spring or elastic bumper 132 and the spring or elastic bumper 134 may function to restrict the movement of the displacement unit 106.

One end of the spring or elastic bumper 132 may be affixed to the second shaft 124 or the support housing 108, and the other end of the spring or elastic bumper 132 may be affixed to the displacement unit 106. One end of the spring or elastic bumper 134 may be affixed to the second shaft 124 or the support housing 108, and the other end of the spring or elastic bumper 134 may be affixed to the displacement unit 106. The spring or elastic bumper 132 and the spring or elastic bumper 134 may have the same elasticity (the same spring constant), or may have the different elasticities (the different spring constants).

According to the first embodiment, the rotation movement of the cylindrical cam 112 is translated into the oscillation movement of the displacement unit 106 using the planar follower 120 having the first pin 116 and the second pin 128. With this configuration, since the cylindrical cam 112 and the displacement unit 106 are arranged along parallel axes, the stroke length of the oscillation movement of the displacement unit 106 can be amplified. However, instead of the planar follower 120 having the first pin 116 and the second pin_128, a different slot-follower connection can be used to effectively translate the rotation movement of the cylindrical cam 112 into the oscillation movement of the displacement unit 106.

Two different endless grooves (the first trajectory and the second trajectory) may be formed on the same curved surface of the cylindrical cam 112. The two different endless grooves may be formed such that the first pin 116 moves along the first trajectory when the first shaft 110 of the rotation motor 102 rotates in a clockwise direction, and the first pin 116 moves along the second trajectory when the first shaft 110 of the rotation motor 102 rotates in a counterclockwise direction.

The follower 120 may be formed into a rod shape, instead of the plate shape.

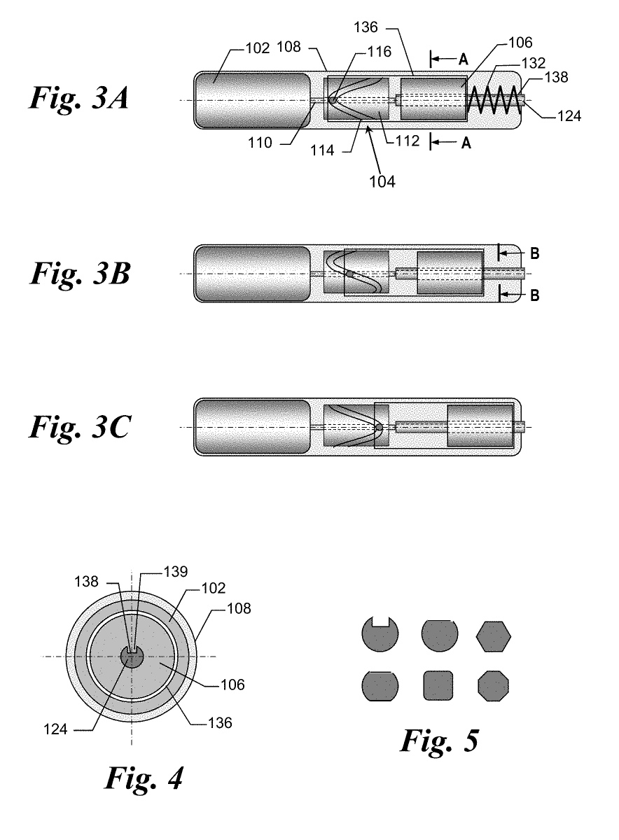

Refer to FIGS. 3A-3C. FIGS. 3A-3C illustrate a haptic actuator according to a second embodiment of the present invention. As shown in FIGS. 3A-3C, the haptic actuator according to the second embodiment can be implemented within a support housing 108 having a cylindrical shape.

In the haptic actuator according to the second embodiment, the cylindrical cam 112 of the rotation-to-oscillation converter 104 and the displacement unit 106 are concentrically arranged along the axis of the first shaft 110 of the rotation motor 102. Thus, the amplification effect for the stroke length of the oscillation movement of the displacement unit 106 may not be obtained.

FIGS. 3A-3C illustrate the displacement unit 106 at the different positions within one period of the oscillation movement. FIG. 4 illustrates a cross section taken along a line A-A in FIG. 3A.

The second shaft 124 is arranged concentrically with the first shaft 110 of the rotation motor 102. One end of the second shaft 124 is affixed to the support housing 108, and the other end of the second shaft 124 extends toward the first shaft 110 of the rotation motor 102.

The displacement unit 106 oscillates along the second shaft 124. The second shaft 124 has a groove 138 formed along an axis direction, and the displacement unit 106 has a protrusion 139 entering into the groove 138. The groove 138 and the protrusion 139 function as a rotation prevention mechanism to prevent a rotation of the displacement unit 106.

As the rotation prevention mechanism, the second shaft 124 may have a rib formed along the axis direction, and the displacement unit 106 may have a recess receiving the rib. Alternatively, the cross-sectional shape of the connection portion between the second shaft 124 and the displacement unit 106 may be formed as exemplified in FIG. 5.

A pipe-shaped follower 136 is rigidly fixed to an outer peripheral surface of the displacement unit 106. The follower 136 is concentrically arranged with the first shaft 110 and the displacement unit 106. A portion of the follower 136 extends toward the cylindrical cam 112.

A pin 116 is provided on an inner circumferential surface of the extended portion of the follower 136, and a groove 114 is formed on an outer peripheral surface of the cylindrical cam 112. As the first shaft 110 of the rotation motor 102 rotates, the pin 116 moves along the groove 114, and thus, the follower 136 is caused to slide back and forth along the first shaft 110. Accordingly, the displacement unit 106 fixed with the follower 136 also moves back and forth (oscillates).

A spring or elastic bumper 132 may be further provided on the second shaft 124, as shown in FIG. 3A. The spring or elastic bumper 132 may function to restrict the movement of the displacement unit 106.

One end of the spring or elastic bumper 132 may be affixed to the second shaft 124 or the support housing 108, and the other end of the spring or elastic bumper 132 may be affixed to the displacement unit 106.

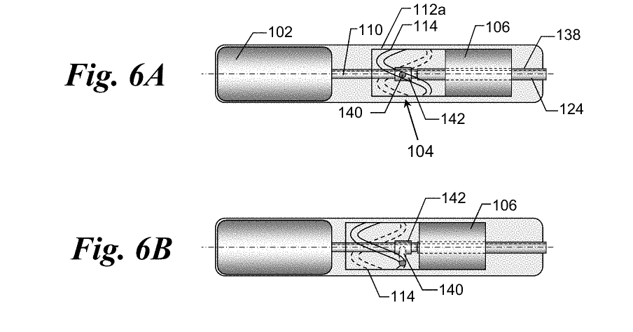

Refer to FIGS. 6A and 6B. FIGS. 6A and 6B illustrate a haptic actuator according to a third embodiment of the present invention.

In the haptic actuator according to the third embodiment, in contrast to the haptic actuator according to the second embodiment, the cylindrical cam 112a of the rotation-to-oscillation converter 104 is formed as a part of the displacement unit 106, or is rigidly fixed to the displacement unit 106.

Specifically, a part extended toward the first shaft 110 or the whole of the displacement unit 106 functions also as the cylindrical cam 112a, and the groove 114 is formed on an inner peripheral surface thereof. In this case, the inner peripheral surface of the displacement unit 106 or the cylindrical cam 112a functions as the curved surface on which the groove 114 is to be formed. The groove 114 may be formed by cutting through the inner peripheral surface of the displacement unit 106 or the cylindrical cam 112a to have the predefined trajectory.

The displacement unit 106 or the cylindrical cam 112a has a thickness sufficient for forming the groove 114 thereon. The groove 114 may be formed as a slot.

A sleeve 142 is rigidly fixed on the first shaft 110 of the rotation motor 102, and a pin 140 protrudes from the sleeve 142 in a radial direction. The pin 140 is inserted into the groove 114 formed on the inner peripheral surface of the displacement unit 106 or the cylindrical cam 112a. As the first shaft 110 of the rotation motor 102 rotates, the pin 140 moves along the groove 114, and thus, the displacement unit 106 or the cylindrical cam 112a moves back and forth (oscillates) along the second shaft 124.

In the third embodiment, the pin 140 provided on the first shaft 110 of the rotation motor 102 functions as the follower connecting the first shaft 110 and the displacement unit 106. While the displacement unit 106 and the cylindrical cam 112a are allowed to move back and forth in an axial direction of the first shaft 110 of the rotation motor 102, they are prevented from rotating.

FIGS. 6A and 6B illustrate the displacement unit 106 at the different positions within one period of the oscillation movement.

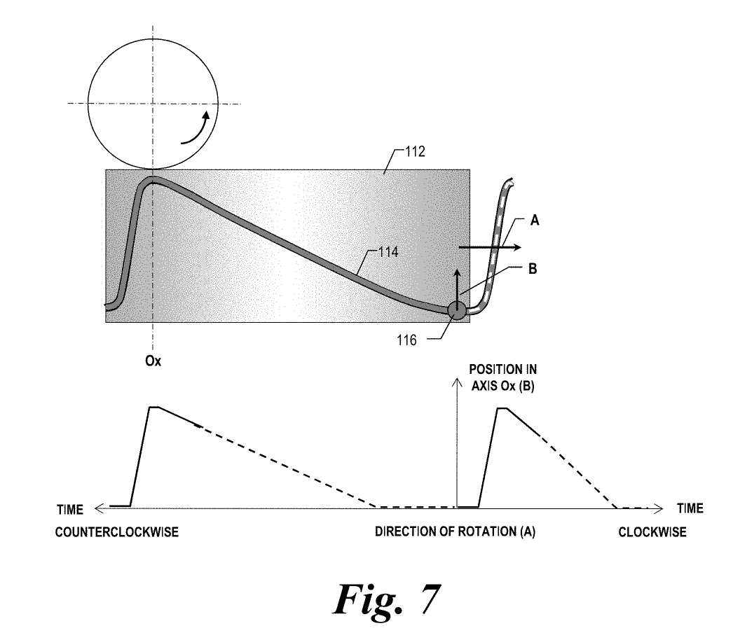

FIG. 7 illustrates function and operation of the rotation-to-oscillation converter 104.

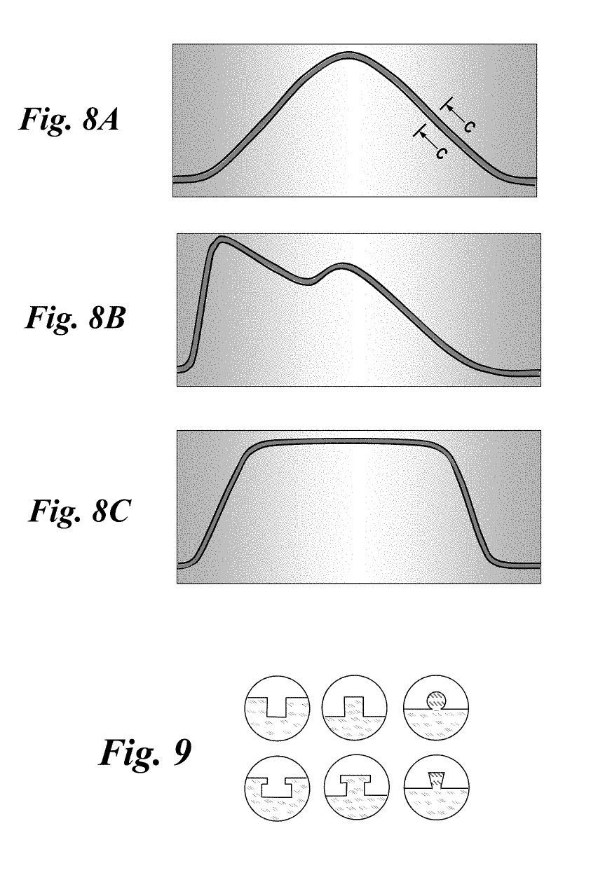

FIGS. 8A-8C illustrate formation patterns of the slot or groove for defining the trajectory of the pin to cause the displacement unit 106 to oscillate.

FIG. 9 is a cross-sectional view of the slot or groove taken along a line C-C in FIG. 8A

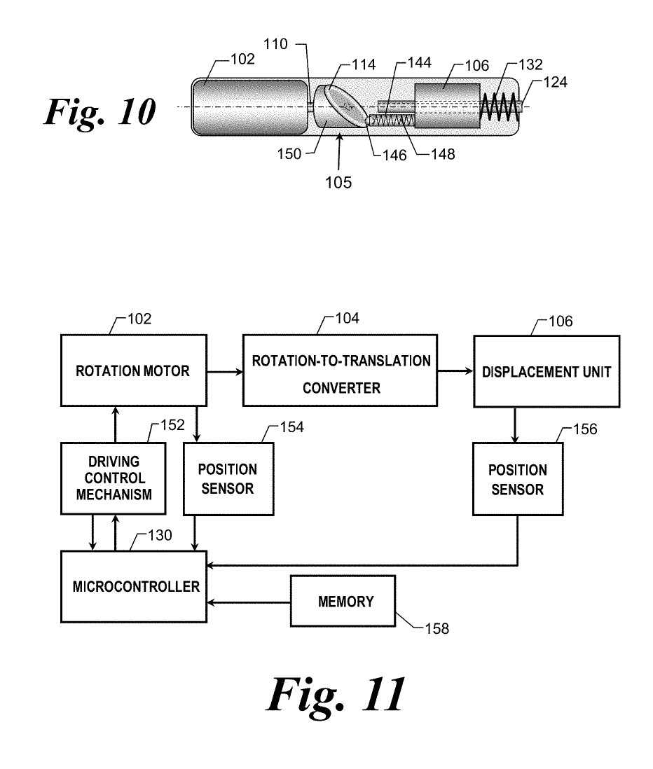

Refer to FIG. 10. FIG. 10 illustrates a haptic actuator according to the fourth embodiment of the present invention. The haptic actuator according to the fourth embodiment uses an inclined cam, instead of the cylindrical cams 112 and 112a used in the first to third embodiment.

The haptic actuator according to the fourth embodiment includes a rotation-to-oscillation converter 105. The rotation-to-oscillation converter 105 includes an inclined cam 150 rigidly fixed to the first shaft 110 of the rotation motor 102. The inclined cam 150 has an obliquely-cut-out cylinder shape in which a part of a cylinder is obliquely cut out.

While the displacement unit 106 is allowed to move back and forth in the axial direction of the first shaft 110 of the rotation motor 102, it is prevented from rotating.

Along a peripheral edge of the cut-out ellipse surface of the inclined cam 150, a trajectory 114 is formed. On the other hand, a rod-shaped follower 144 protrudes toward the inclined cam 150. A spring or elastic bumper 132 is provided on the second shaft 124 to restrict the movement of the displacement unit 106 and to push back the displacement unit 106 toward the inclined cam 150. A contact between a tip of the follower 144 and the trajectory 114 form a cam joint 146. The cam joint 146 may be configured in a different manner.

As the first shaft 110 the rotation motor 102 rotates, the inclined cam 150 also rotates, and the follower 144 slides back and forth by being guided by the trajectory 114 of the inclined cam 150. Thus, in accordance with a sliding movement of the follower 144, the displacement unit 106 moves back and forth (oscillates) along the second shaft 124 while being urged by the spring or elastic bumper 132.

In the fourth embodiment, the follower 144 may be provided with a return spring 148 to have an elasticity. Alternatively, to improve the followability of the follower 144 to the trajectory 114, the tip of the follower 144 may be configured by a ball.

Refer to FIG. 11. FIG. 11 illustrates the block configuration of the haptic actuator according to the present invention integrated with sensors and a microcontroller.

The sensors include, for example, a position sensor (rotation angle sensor) 154 of the first shaft 110 of the rotation motor 102, and a position sensor 156 of the displacement unit 106. The position sensor 154 may be affixed to the first shaft 110, or may be integrated inside the rotation motor 102 as in the case of the stepper motor design. The position sensor 156 is provided on the support housing 108 or the circuit board (not shown) for electronic components at a position near the movement trajectory of the displacement unit 106.

The deriving control mechanism 152 may perform control of the rotation motor 102 in different manner depending on a type of the rotation motor 102. Based on the sensor signals from the position sensors 154, 156 and the feedback signals from the driving control mechanism 152, a microcontroller 130 may adjust actuation parameters according to the haptic patterns stored in a memory 158.

The microcontroller 130 may acquire the rotation speed and the oscillation frequency of the rotation-to-oscillation converter 104 based on the rotation speed of the first shaft 110 of the rotation motor 102 detected by the position sensor 154 and the position of the displacement unit 106 detected by the position sensor 156, and may control the memory 158 to store these information in association with the haptic patterns,

The present invention is not limited to the above-mentioned embodiments, but may be embodied, for example, by modifying components without departing from the spirit and scope of the invention. Various inventions can be formed by appropriately combining multiple components in the embodiments. For example, some of all the components in the embodiments may be deleted, and/or components used in different embodiments may be combined appropriately.

For example, the microcontroller 130 and the position sensors 154, 156 may provided or omitted. In this case, the deriving control mechanism 152 may perform control of the rotation motor 102 depending only on its type, such as a DC motor, an AC motor, or a stepper motor.

1. A haptic actuator, comprising:
a housing;
an actuator having a first shaft and configured to rotate the shaft;
a rotation-to-translation converter being coupled to the first shaft of the actuator; and
a second shaft provided in parallel to or in coaxial with the first shaft of the actuator; and
a displacement unit configured to move along the second shaft depending on a movement of the rotation-to-translation converter.

2. The haptic actuator of claim 1,
wherein the rotation-to-translation converter comprising:
a cylindrical cam having a closed-endless-loop groove formed on a curved surface thereof;
a follower having a first slot and a second slot and configured to connect the cylindrical cam and the displacement unit;
a first pin; and
a second pin,
wherein the first pin is movable within the first slot of the follower along a trajectory of the groove, and
wherein the second pin is connected with the displacement unit, and is movable within the second slot of the follower.

3. The haptic actuator of claim 2,
wherein a third shaft is affixed to the housing so as to be in parallel with the first shaft of the actuator, and
wherein the follower has a plate shape, and is pivotally supported on the third shaft.

4. The haptic actuator of claim 2,
wherein the displacement unit is configured to oscillate along the second shaft in accordance with a swinging movement of the follower.

5. The haptic actuator of claim 2,
wherein a third shaft is affixed to the housing so as to be in parallel with the first shaft of the actuator, and
wherein the follower has a rod shape, and is pivotally supported on the third shaft.

6. The haptic actuator of claim 1,
wherein springs or elastic bumpers are provided on both ends of the second shaft, respectively, so as to restrict a movement of the displacement unit.

7. The haptic actuator of claim 6,
wherein each of the springs or elastic bumpers is disposed such that one end is coupled to the second shaft or the housing, and the other end is coupled to the displacement unit.

8. The haptic actuator of claim 6,
wherein the springs or elastic bumpers have different spring constants, or the same spring constant.

9. The haptic actuator of claim 2,
wherein two closed-endless-loop grooves are formed on the curved surface of the cylindrical cam,
wherein a first trajectory of the two grooves guides the first pin when the first shaft of the actuator rotates in a clockwise direction, and
wherein a second trajectory of the two grooves guides the first pin when the first shaft of the actuator rotates in a counterclockwise direction, and

10. The haptic actuator of claim 1,
wherein the second shaft is arranged concentrically with the first shaft, such that one end there of is affixed to the housing, and the other end extends toward the first shaft,
wherein the second shaft has a rotation prevention mechanism which restricts a rotation of the displacement unit in a circumferential direction, while allowing a movement of the displacement unit in an axial direction,
wherein the rotation-to-oscillation converter includes a cylindrical cam having a closed-endless-loop groove formed on a curved surface thereof, and rigidly fixed to the first shaft of the actuator;
wherein a pipe-shaped follower is rigidly fixed to an outer peripheral surface of the displacement unit,
wherein a pin is provided on an inner circumferential surface of an extended portion of the follower, and
wherein, when the first shaft of the actuator rotates, the pin guides the groove.

11. The haptic actuator of claim 10,
wherein a spring or elastic bumper is provided on the second shaft between the displacement unit and the housing.

12. The haptic actuator of claim 10,
wherein the second shaft is arranged concentrically with the first shaft, such that one end there of is affixed to the housing, and the other end extends toward the first shaft,
wherein the second shaft has a rotation prevention mechanism which restricts a rotation of the displacement unit in a circumferential direction, while allowing a movement of the displacement unit in an axial direction,
wherein a cylindrical cam as the rotation-to-oscillation converter is rigidly fixed on the displacement unit or is formed as a part thereof, and
wherein the cylindrical cam has a closed-endless-loop groove or slot formed on an inner circumferential surface as a curved surface thereof,
wherein a sleeve is rigidly fixed on the first shaft of the actuator, and a pin protrudes from the sleeve in a radial direction, and
wherein, when the first shaft of the actuator rotates, the pin moves within the groove or slot to thereby cause the cylindrical cam and the displacement unit to move along the second shaft.

13. The haptic actuator of claim 1,
wherein the second shaft is arranged concentrically with the first shaft, such that one end there of is affixed to the housing, and the other end extends toward the first shaft,
wherein the second shaft has a rotation prevention mechanism which restricts a rotation of the displacement unit in a circumferential direction, while allowing a movement of the displacement unit in an axial direction,
wherein the rotation-to-oscillation converter includes an inclined cam having an obliquely-cut-out cylinder shape in which a part of a cylinder is obliquely cut out, and rigidly fixed to the first shaft of the actuator,
wherein a rod-shaped follower protrudes from the displacement unit toward the inclined cam,
wherein a spring or elastic bumper is provided on the second shaft urge the displacement unit toward the inclined cam to thereby cause a tip of the follower to contact a cut-out ellipse surface of the inclined cam, and
wherein, when the first shaft of the actuator rotates, the follower moves along the cut-out ellipse surface of the inclined cam, to thereby cause the displacement unit to move along the second shaft.
